(19) United States
(12) Patent Application Publication
(10) Pub. No.: US 2008/0228557 A1
(43) Pub. Date: Sep. 18, 2008

(54) Method And Apparatus For Measuring Distinctions Between Pre-paid vs. Post-paid Customer Base And Market Share For Wireless Communication Service Products

(75) Inventors: Hossein Alexander Sepehri-Nik, Coral Gables, FL (US); Vagner Caetano da Silva, Sao Paulo (BR); Milton Mitsuharu Yoshimura, Sao Paulo (BR)

Correspondence Address: KAPLAN GILMAN GIBSON & DERNIER L.L.P., 900 ROUTE 9 NORTH, WOODBRIDGE, NJ, 07095, US

(73) Assignee: MOBILE SCIENCE, LTD., Miami, FL (US)

(21) Appl. No.: 12/022,763

(22) Filed: Jan. 30, 2008

Related U.S. Application Data
(60) Provisional application No. 60/893,922, filed on Mar. 9, 2007.

(51) Int. Cl. G06F 17/30

(52) U.S. Cl. 705/10

(57) ABSTRACT

Methods and systems are provided for determining customer distinctions for one or more wireless communication service providers. Determinations are drawn from a sampling of telephone numbers that have been determined to be assigned by wireless service provider(s) (to its/their customers) and are employed to determine whether the assigned number is assigned to a pre-paid “customer” or a post-paid “subscriber” of the carrier(s). A message is sent to the telephone number and the response is interpreted to determine whether that assigned number is assigned (by the carrier) to a pre-paid customer or a post-paid subscriber. Alternatively, a sampling of telephone numbers from one or more service providers are sent messages to determine pre-paid customer/post-paid subscriber ratios of these carrier(s), based upon a preset numbering scheme that differentiates between the two categories (pre-paid “customers” vs. post-paid “subscribers”). Alternatively, once a number is determined to be assigned by a carrier, a determination as to whether that number is assigned to a pre-paid customer or a post-paid subscriber is performed through inquiries into the service provider's customer database/billing records.

### CROSS-REFERENCE TO RELATED APPLICATIONS

This application claims the benefit of U.S. Provisional Patent Application Ser. No. 60/893,922, filed Mar. 9, 2007, the entirety of the disclosure of which application is incorporated herein by reference.

### FIELD OF INVENTION

The present invention relates to the measurement of wireless communication services pre-paid “customers” vs. post-paid “subscribers” statistics and ratios. More particularly, the present invention relates to a method and apparatus for measuring pre-paid vs. post-paid market statistics for wireless communications service providers.

### BACKGROUND OF THE INVENTION

Wireless communications have become prevalent all over the world. However, the wireless markets in the many countries of the world have many different looks to them. In the United States approximately 95% of wireless communications users are what is referred to as post-paid “subscribers”. This generally means that the subscriber enters into a contract for service (with a wireless service provider) for a term of service. The post-paid subscriber then uses a wireless communications device on the wireless service provider's network. Then, at some later point, the subscriber receives a bill from the service provider for the service(s) that he/she has used up to a certain date.

The remaining 5% of wireless users in the United States are pre-paid “customers”. This means that the customer is assigned a number from a wireless service provider and then pays a certain amount for network usage in advance of incurring any charges. Once the amount previously paid to the wireless service provider is used up, it is up to the customer to deposit more money into their wireless account so that they may use their wireless device some more.

As the percentages above show, the pre-paid market in the US is minute compared to the post-paid market. This is not reflective of the wireless market everywhere. For instance, in most of South America approximately ninety percent (90%) of wireless communications users are pre-paid customers versus approximately ten percent (10%) post-paid subscribers.

In most countries that have a predominantly pre-paid customer base, the profit margins on these pre-paid services are extremely small relative to the margins on the post-paid services. This is partially driven by the fact that the customers needing to purchase pre-paid services are often doing so because they have limited disposable income for such services and perhaps little, or no credit. As such, they need to purchase smaller packages without many extras—as their finances allow. These pre-paid packages allow them access to these forms of wireless communications.

In contrast, the post-paid subscriber market in these countries (although smaller in percentage), make up a much more profitable market for the wireless service providers. These post-paid subscribers tend to be wealthier individuals, business accounts, or other types of subscribers that simply have more credit and/or money to pay for these services. For the most part, these post-paid subscribers have already subscribed to a wireless service provider—and competition for their (more lucrative) business is fierce amongst the carriers.

As this battle for post-paid subscribers rages on, the wireless service providers need to obtain reliable market statistics about their customer-base, as well as those of their competition, in order to make strategic and tactical decisions. Since wireless service providers are competing over the same post-paid subscribers, these wireless service providers are not inclined to share customer/subscriber-base information with their competitors. Accordingly, it is necessary for these wireless service providers to obtain reliable measurements of market share information broken down by pre-paid versus post-paid market segments.

“Gross” market share information is sometimes available to wireless service providers. This means that information is sometimes available to the service providers regarding what percentage, or share, of the total (pre-paid plus post-paid ) wireless market they maintain.

This “gross” market share information can be gathered in a number of ways. For instance, in Brazil, gross market share information is publicly reported on a monthly basis by ANATEL—the country's equivalent of the FCC in the USA.

As mentioned above however, the real interest (and fiercest competition) in some countries, such as those in South America, is with respect to the post-paid “subscriber” market. This is where a given wireless service provider wishes to know what percentage of market share that they have had historically and/or currently maintain, and whether they are losing these post-paid subscribers over time—and if so, who are they losing them to and why.

Accordingly, it would be desirable to provide methods and apparatus that can provide statistically accurate estimates of “pre-paid customer-base” versus “post-paid subscriber-base” ratios for wireless communications market statistics. It would also be desirable to provide measurements other than simple market share, such as pre-paid and post-paid churn and gross additions.

### SUMMARY OF THE INVENTION

The present invention provides methods and apparatus for determining pre-paid versus post-paid market statistics regarding pre-paid “customer”/post-paid “subscriber” ratios of wireless communication service providers. The present invention employs determinations of whether or not a sampling of telephone numbers that are determined to be assigned by a particular service provider are assigned to a pre-paid customer or to a post-paid subscriber, in order to determine market statistics.

In accordance with one embodiment of the present invention, a method is provided wherein a message is sent to a telephone number and the response is interpreted to determine whether that assigned number is assigned (by the carrier) to a pre-paid customer or a post-paid subscriber. In a preferred embodiment the method employs an automated SS7 signal interpretation algorithm.

In another embodiment, a numbering assignment interpretation method is provided wherein a sampling of telephone numbers from one or more service providers are sent messages to determine the customer/subscriber ratios of a given carrier's customer base, based upon a predetermined numbering assignment scheme that differentiates between the two categories i.e., pre-paid “customers” vs. post-paid “subscribers”. Once the determinations of assigned/unassigned numbers are complete the results are used to calculate the carriers' prepaid/postpaid customer-base ratios.

In another embodiment a method is provided wherein once a number is determined to be assigned by a carrier, a determination as to whether that number is assigned to a pre-paid customer or a post-paid subscriber is performed through inquiries into the service provider's customer database/billing records.

In a further embodiment a system is provided that is adapted to determine whether a telephone number is assigned to a pre-paid customer or to a post-paid subscriber, the system including a data collection component comprising a SS7 test device adapted to coordinate testing of a sample of numbers, which test device interfaces to a SS7 network,

a central server, at least one data collection node adapted to control the test device coordinating the testing of a sample of numbers, the at least one node connected via a network connection to the central server, the central server adapted to use publicly available data about wireless service provider line number range assignments to generate, maintain, and store carrier-market samples, and at least one reporting mechanism.

### BRIEF DESCRIPTION OF THE DRAWINGS

Other objects and advantages of the invention will become apparent to those skilled in the art upon reading the following detailed description of preferred embodiments, in conjunction with the accompanying drawings, wherein like reference numerals have been used to designate like elements, and wherein:

FIG. 1 is a diagrammatic representation of a general environment within which one or more embodiments of the present invention are employed;

FIG. 2 is a block diagram depicting a method in accordance with at least one embodiment of the present invention;

FIG. 3 is a block diagram depicting a method of testing carrier-market samples in accordance with at least one embodiment of the present invention;

FIG. 4 is a block diagram depicting a method of testing an individual number from a carrier-market sample in accordance with at least one embodiment of the present invention;

FIG. 5 is a block diagram depicting a method of determining whether a number is assigned or unassigned in accordance with at least one embodiment of the present invention;

FIG. 6 is a block diagram depicting a method of classifying a number in accordance with at least one embodiment of the present invention;

FIG. 7 is a diagrammatic representation of a method in accordance with at least one embodiment of the present invention; and

FIG. 8 is a diagrammatic representation of a logical architecture of a system in accordance with at least one embodiment of the present invention.

### DETAILED DESCRIPTION OF THE PREFERRED EMBODIMENTS

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment.

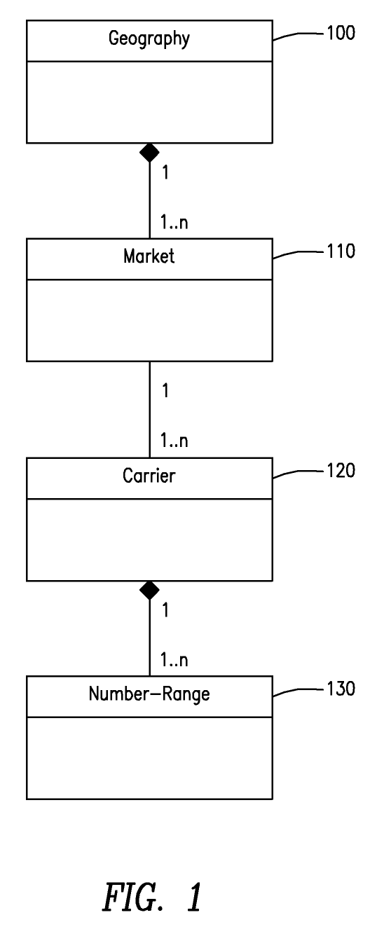

With reference to the drawings, wherein like numerals indicate like elements, there is shown in FIG. 1 in accordance with at least one embodiment, a simplified block diagram depicting a framework within which the present inventions are employed. A geographic region 100 is segmented into one or more wireless markets 110. Each market 110 is in turn served by one or more wireless service providers (or “carriers”) 120. The combination of a carrier 120 and a market 100 is referred to as a “carrier-market”. Each carrier 120 is allocated ranges of numbers in blocks, identified as carrier number ranges 130. When Local Number Portability (LNP) is not in effect, a number is associated with the market 110 corresponding to the carrier number range 130 of which it is a part. When LNP is in effect, the market 100 may be determined by querying the Local Number Portability (LNP) database.

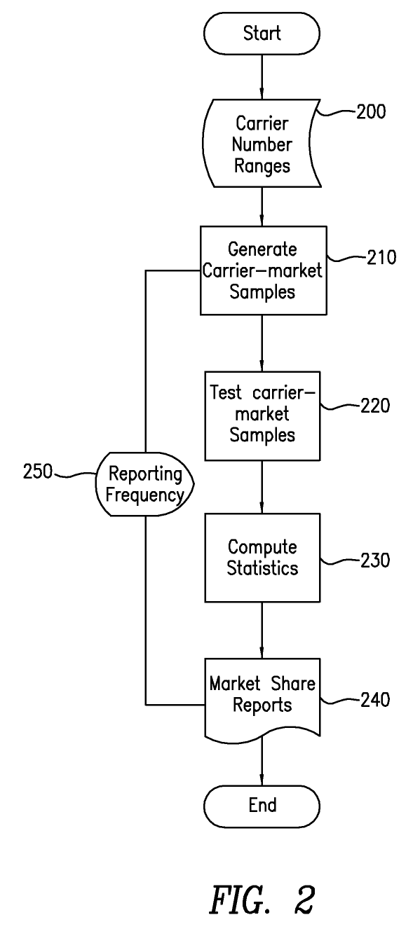

FIG. 2 illustrates a method of collecting and classifying carrier-market information. As is well known in the art, within a SS7 network, the point codes are numeric addresses which uniquely identify each signalling point and the Destination Point Code (DPC) identifies the receiving signalling point. In the present invention, publicly available information about carrier number ranges 130 for each carrier-market and the Destination Point Code (DPC) to address each carrier on the SS7 network is collected at step 200. At step 210, for each carrier-market a random, and statistically significant, sample of numbers is generated. The generation of carrier-market samples 210 involves in one embodiment using this information to generate samples of test numbers that accurately represent the population of numbers in each carrier-market. The generated samples include any relevant information that is associated with the line range that the number is contained in, such as the HLR DPC and any knowledge about whether the number is pre-paid or post-paid. Generated samples are stored in a database. At selected intervals, such as but not limited to at least once each reporting period, each sample of numbers is tested at step 220 for each carrier-market for which reporting is provided. The test classifies the number as assigned or unassigned and further classifies assigned numbers as pre-paid or post-paid. Result information is stored such as in a database, server, warehouse or the like. At step 230 statistics are computed regarding the percentage and distribution of pre-paid and post-paid numbers in a carrier market. In step 240 reports are generated using current and historic result information.

It will be apparent to those skilled in the art that the reporting frequency 250 may be any suitable frequency such as but not limited to hourly, daily, weekly or the like. In addition, samples can be regenerated as needed.

It will be further understood that the generation of representative samples is not limited to any single method. For example, it is believed a representative sample may be achieved by generating an even distribution of random numbers within an allocated number block range. However, other factors may be considered and employed in generating a representative sample.

Methods of generating a sample of test numbers for each carrier-market are known in the art. For example, a database of carrier-market information may be initialized and periodically updated with information about number allocations to markets and with information necessary to address relevant carrier network equipment on the SS7 network. The process of generating samples may be iterated over the set of all carriers of interest. For each carrier the process of generating samples may then iterate over each market. For each carrier-market the population of numbers allocated to the carrier may be determined using information stored in the carrier database. A randomly selected, statistically significant, subset of numbers within the population may then be generated. The numbers that compose the carrier-market sample are stored in a database for later testing. Relevant attributes for the carrier or number block may be stored with each number. For example, the SS7 Destination Point Code (DPC) of the carrier Home Location Registry (HLR) may be associated with each number. In one embodiment, in cases in which the number is pre-paid or post-paid is an attribute of the number range of which the number is a part, this attribute may also be stored.

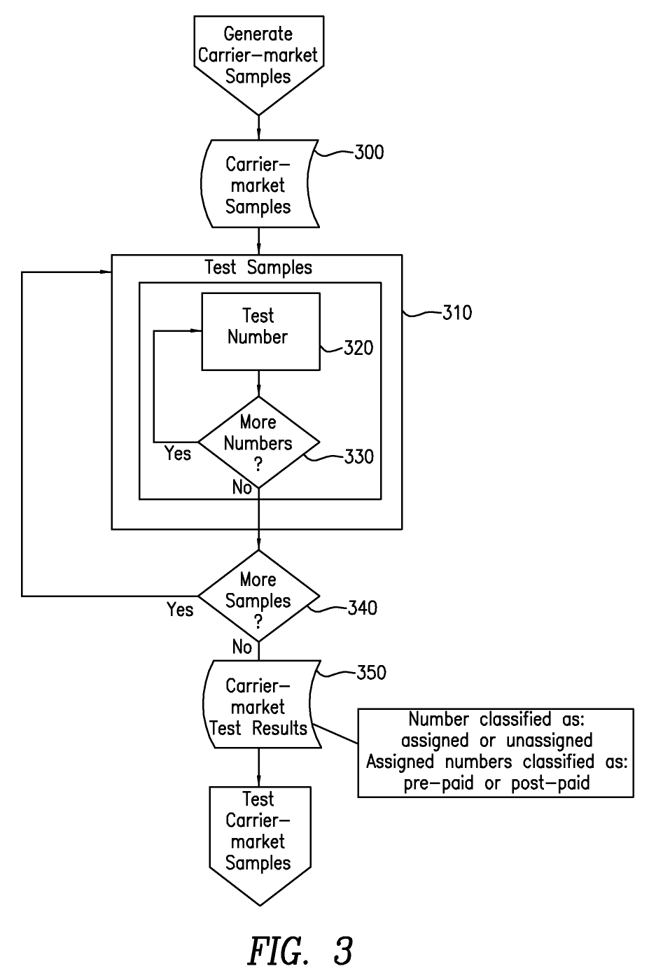

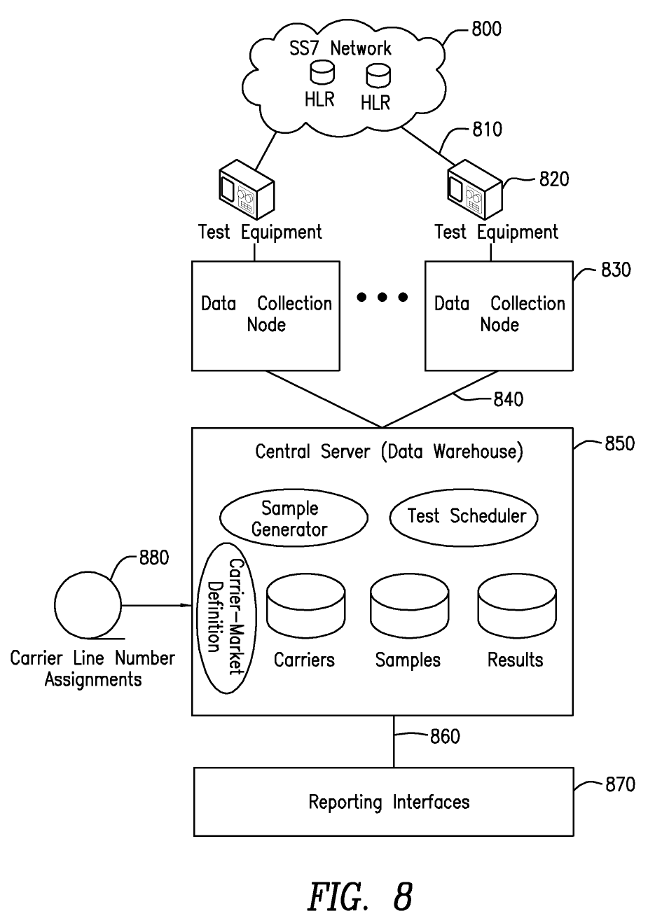

FIG. 3 illustrates a method of testing carrier-market samples. This is preferably an iterative process that operates on each sample of numbers generated during the “generate carrier-market samples” step described above and stored in the carrier-market sample database (300). Each number in the sample is tested (320) to determine if it is assigned or unassigned. Numbers classified as assigned are further tested and classified as either pre-paid or post-paid. Results are stored in a results database. In some cases it may occur that the result of testing a number is indeterminate, due perhaps to a transient network condition. In such cases in one embodiment the test result for the number is marked as such and the number may be retested at a future time. It is preferred that the entire testing process be complete within the time required by the desired reporting cycle. As further illustrated in FIG. 8, a system using the method may be implemented such that multiple data collection nodes and multiple pieces of SS7 test equipment are used as necessary to achieve the systems' test throughput requirements.

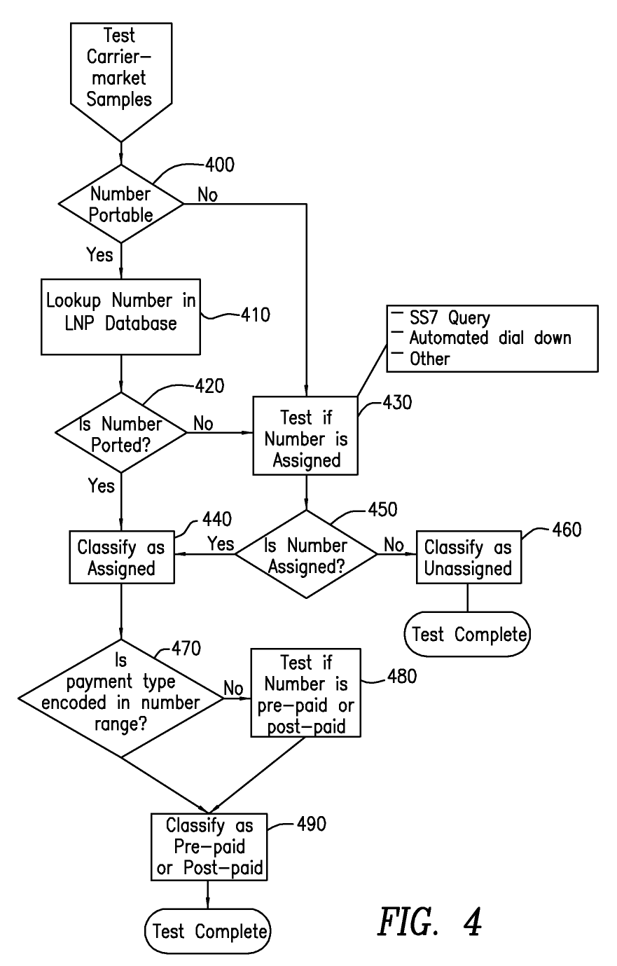

FIG. 4 illustrates a process of testing an individual number from a carrier-market sample. If Local Number Portability (LNP) is supported (400), an SS7 request is issued to query the LNP database for the number. If the number is found (420) it is by definition assigned to a subscriber and is classified as such. Otherwise, if LNP is not supported or the number was not found in the LNP database, one of several possible methods are used to determine if the number is assigned or unassigned. For example, a SS7 query can be implemented or an automated or manual dial down can be performed. If the number is unassigned (450) it is classified as such (460) and testing of the number is complete. As is described further hereinbelow, further determining whether an assigned number is pre-paid or post-paid may occur in several ways depending on the characteristics of the carrier-market. In some cases it may be an attribute of the number range of which the number is a member (470) in which case no further testing is required. In some cases it may be evident from the test results from testing whether the number is assigned or unassigned. If neither of these cases is true, the assigned number is further tested to determine whether the number is pre-paid or post-paid (480). The number is then classified based on the results of the test (490).

It will be apparent to those skilled in the art that a variety of methods may be employed to determine whether or not a number is assigned to a subscriber. These methods range from the manual or automated calling of numbers to the use of SS7 signaling to query the carrier's HLR. Applicable techniques depend on the characteristics of the carrier-market network under test. For example, the methods described in U.S. Pat. No. 6,751,295, incorporated in its entirety herein by reference, may be employed.

In an embodiment a method may be employed which tests the assignment status of a Mobile Identification Number (MIN). A data collection computer may be adapted to receive the MIN to be tested and the Destination Point Code (DPC) for the wireless service provider's Home Location Registry (HLR). The data collection computer sends an Initiate “Query With Permission” type Qualification Request message to the test equipment. This message contains the number to be tested, the DPC for the carrier HLR, an invalid Electronic Serial Number (ESN) value, and other information required to form a valid message. The test equipment sends the Qualification Request message to the HLR, which upon receiving the message will attempt to validate the correspondence between the MIN and the ESN. If the MIN is found in the HLR database the HLR sends a reply with an error that indicates a mismatch with the supplied invalid ESN. When a reply containing such an error is received, the number is concluded to be assigned to a subscriber. If the number is not found in the HLR database, the HLR sends a reply containing a different type of error. In this case it is concluded that the number is not assigned. If a reply is not received from the HLR within the configured timeout threshold, the system marks the result as indeterminate and will schedule to re-test the number at a future time.

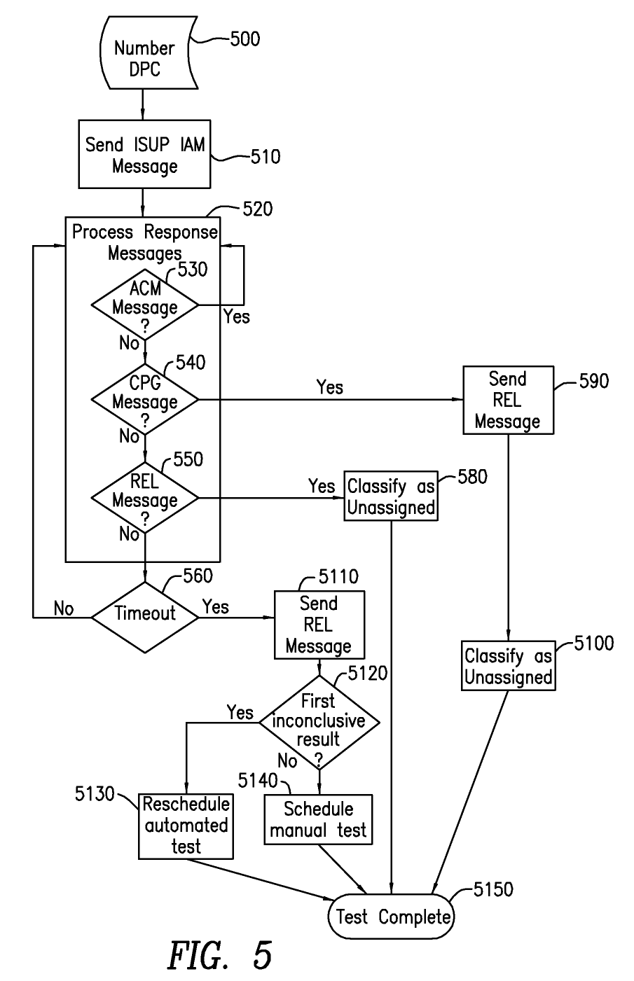

Now referring to FIG. 5, in one embodiment a method is illustrated that uses ISDN User Part Protocol (ISUP) to generate the signaling necessary to initiate, and immediately terminate, a call to the number under test. In one embodiment the method is implemented by a system having architecture such as that depicted in FIG. 8, described in further detail hereinbelow. An ISUP IAM (Initial Address Message) is sent (510) to the destination switch for the number under test. The system then enters a loop waiting for response messages (520). If an ACM (Address Complete Message) is received (530) the system returns to wait for a CPG (Call Progress Message) (540). When a CPG message is received, the system sends a REL message (590) to terminate the call, classifies the number as assigned (5100), and terminates the test (5150). If a REL message is received (550) the system classifies the number as unassigned (580) and terminates the test (5130). If the system does not receive the expected messages within a configured timeout threshold, it sends a REL message (5110) to terminate the call. If this is the first inconclusive result (5120) the number is scheduled for automated retest (5130); otherwise, the number is schedule for classification using a manual testing method (5140).

Several methods can be used for determining whether an assigned number is pre-paid or post-paid. In one embodiment a method includes using knowledge about number range assignments to make such identification. In another embodiment, a method is employed which decodes information from SS7 signaling that identifies whether the assigned number is pre-paid or post-paid. In another embodiment, a method employs extracting CDRs (Call Data Records) from the carrier's billing system.

In accordance with one embodiment, a method is provided using knowledge about number range assignments to make an identification of whether an assigned number is pre-paid or post-paid. As mentioned above, in some cases, whether an assigned number is pre-paid or post-paid is an attribute of the number range of which the number is a member. In such event the method includes identifying the attribute and analyzing a selected assigned number to determine whether it contains the attribute.

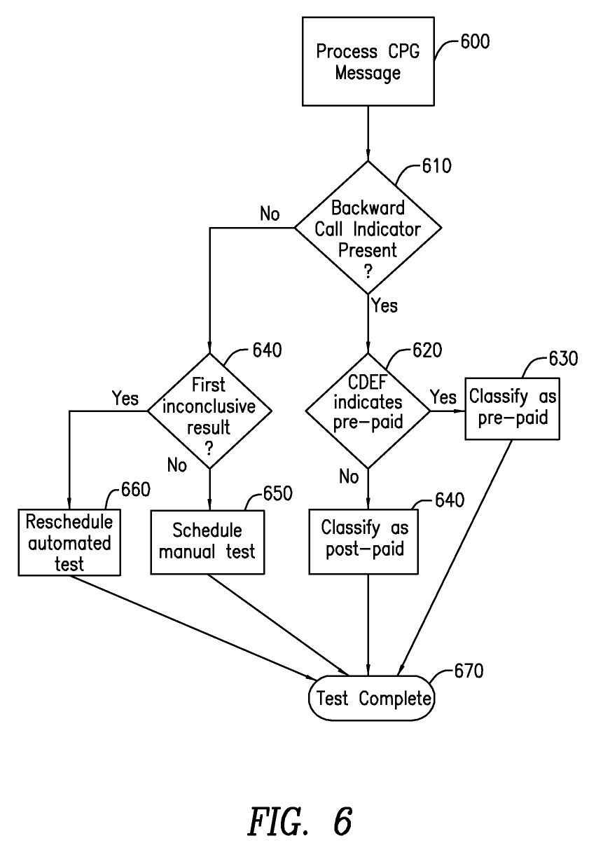

Now referring to FIG. 6 a method is illustrated which employs the use of SS7 signaling to classify whether an assigned number is pre-paid or post paid. In one embodiment this is an additional processing step to the method illustrated in FIG. 5. for determining whether a number is assigned or unassigned. The Call Progress Message (CPG) (600) is examined to determine whether it contains a Backward Call Indicator parameter (610). If present, the CDEF parameter is examined (620) to determine if the number is pre-paid. If so, it is classified as such (630) and testing is terminated (650). If the CDEF parameter indicates the number is post-paid, it is classified as such (640) and testing is terminated. In the event that the CPG message does not contain the required response parameters (610) the result is inconclusive (640). If it is the first inconclusive result the number is scheduled for automated retest (650) at a future time; otherwise, the number is scheduled for classification using a manual testing method (660).

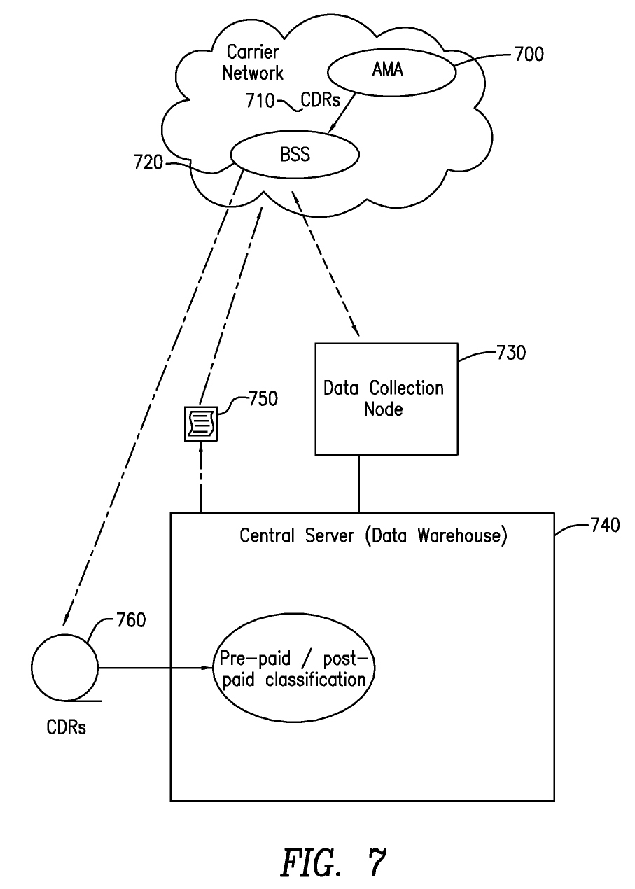

It is observed that for some carrier-markets, the information regarding whether or not a number is pre-paid or post-paid is stored in the billing system and may or may not be encoded in network signaling. It may be desirable to employ a method of extracting such information from the billing system. Now referring to FIG. 7, illustrated is a method of extracting CDRs (Call Data Records) from a carrier's billing system. In one embodiment, when a call is processed, Automatic Message Accounting (AMA) software 700 records/updates CDRs 710 for the number, which includes an indication of whether the number is pre-paid or post-paid. This information is stored in the Billing Support System (BSS) 720. To obtain this information a relationship is established between the measurement system and the carrier. In one embodiment, a data collection node 720 uses network access to obtain the information for the numbers under test. In another embodiment, for a given set of numbers under test 750 the relevant information is exported 760.

Now referring to FIG. 8, illustrated is an embodiment of a logical architecture of a system capable of making the required measurements in order to generate reports in accordance with the present invention. Such a system consists of data collection components 820, 830, a central server 850, and reporting mechanisms 870. The data collection components include an SS7 interface 820, or internal card or external test equipment, that interfaces (810) to the SS7 network 800. As will be apparent to the skilled artisan, there are a variety of possible ways that the test equipment can be connected such as but not limited to a direct A link connection to a Signal Transfer Point (STP) or using a monitoring link to existing A links. Data collection nodes 830 serve as controllers of the test equipment coordinating the testing of a sample of numbers. It is contemplated that there may be a one-to-one correspondence between data collection nodes 830 and test equipment or a single node could control multiple pieces of test equipment. Additional data collection nodes 830 and test equipment can be added as necessary to meet the throughput/scalability requirements of the system. Data collection nodes 830 are connected via a network connection 840 to a central server 850 which uses publicly available data about wireless service provider line number range assignments 880 to generate, maintain, and store carrier-market samples. The central server 850 preferably schedules and load-balances the execution of carrier-market sample tests across data collection nodes 830. The central server 850 stores test results for the period necessary to generate required reports. The central server 850 fulfills the role of test controller and data warehouse. In accordance with one embodiment the system may provide any variety of reporting interfaces 870, such as but not limited to using existing Online Analytical Processing (OLAP) mechanisms to providing customers with direct data feeds.

Once information has been collected regarding pre-paid and post-paid numbers in accordance with the aforementioned techniques, statistics are generated using the information, such as but not limited to pre-paid versus post-paid market share, subscriber churn, gross additions and percentage of customers that switch from pre-paid to post-paid but maintain the same number. It will be recognized that some or all of these statistics may be calculated, and may be calculated in any order.

The calculation of pre-paid versus post-paid market share can be performed while the testing is proceeding or after the testing has been completed. In one embodiment, the calculation includes determining the total number of subscribers for a given provider and either or both of the total number of pre-paid and post-paid subscribers for that provider. This assessment can be made for each provider of interest. For example, and not by way of limitation, wireless service provider A is known or estimated to have a total of 10,000 subscribers, 7,000 of which are pre-paid subscribers. As a result, it can be assumed that 3,000 subscribers are post-paid subscribers for provider A. Thus, the percentage of pre-paid subscribers is 70% and post-paid subscribers is 30%. This calculation can be made for each provider in a given market to determine the total ratio of pre-paid versus post-paid customers.

In addition to calculating pre-paid versus post-paid market share, the system may calculate the number of existing customers that have changed from pre-paid to post-paid, or vice versa, over a specified period. In one embodiment, this determination is made by comparing the pre-paid and post-paid classifications for test numbers between the current reporting period and the prior reporting period.

Subscriber churn is generally recognized as a measurement of how many subscribers terminate wireless service with a particular wireless service provider during a specific time interval. This time interval is typically a month or a quarter. In one embodiment, data collected for example for a list of specific test MINs on January 1 is compared to data collected for the same list of test MINs measured on February 1. For each test MIN it is known whether or not the MIN was assigned or unassigned on January 1, and assigned or unassigned on February 1. Thus, subscriber churn is calculated using the number of test MINs which were assigned on January 1, but were determined to be unassigned on February 1. The result of this comparison is divided by the sample rate to estimate the total churn for each wireless service provider.

In addition, other churn statistics can be calculated, as discussed in U.S. Pat. No. 6,751,295, with specific reference to FIGS. 21A-21C and the text directed thereto, incorporated herein by reference.

Subscriber gross adds is a measurement of how many subscribers begin wireless service during a specific time interval, the time interval typically being a month or a quarter. To determine gross adds, a comparison of data from one test period (such as for example January 1) to another (February 1) is made. It should be recognized that a wireless service provider could have added new line ranges to accommodate expansion after the January 1 measurements but before the February 1 measurements. Thus, a modified set of test MINs will include the test MINs used for the January 1 measurements plus a given sampling rate (for example, 5%) times the number of MINs in the new line range. For example, if wireless service provider A adds a range of 10,000 new MINs in January, the February modified test MINs would include an additional 500 MINs, i.e., 10,000 new MINs times the 5% sampling rate. Thus, the present invention can determine the number of test MINs which were unassigned on January 1 but were assigned on February 1.

To calculate the estimated gross add MINs, the number of MINs unassigned on January 1 which were assigned on February 1 is divided by the sampling rate. As an example, wireless service provider A and wireless service provider B had 73 and 57 test MINs, respectively, unassigned on January 1 and assigned on February 1. Using the 5% sampling rage, the estimated gross adds of MINs for wireless service provider A is 1460 (i.e., 73.div.0.05), and the estimated gross adds of MINs for wireless service provider B is 1140 (i.e., 57.div.0.05). In addition, other gross add formulas may be employed. For example, the gross add formula can be modified such that the denominator represents the average of the subscribers at the beginning of the measurement period and the end of the measurement period. A wireless service provider's subscriber gross add share can also be calculated. For example, wireless service provider A has a subscriber churn share is 56.15%, i.e., 1460.div.(1460+1140). To calculate the gross add percentage for each wireless service provider over the one month period, the estimated gross add MINs is divided by the number of estimated MINs for that wireless service provider at the beginning of the period. Accordingly, the gross add percentage for wireless service provider A is 10.90% (i.e., 1460.div.13,400), and the gross add percentage for wireless service provider B is 6.70% (i.e., 1140.div.17,000).

Since the Location Routing Number obtained using the Local Number Portability DIP identifies to which particular service provider a particular MDN/telephone number is assigned, more detailed market statistics can be generated with this information. Specifically, a measurement of ported subscribers can be calculated. For example, it can be assumed for purposes of illustration that on January 1, 10,000 telephone numbers are sampled, and that each sample is served by its native service provider, i.e., the Location Routing Number field of the SS7 DIP response message indicates no Location Routing Number. Performing the Local Number Portability database DIP on February 1 for the same market can identify the switch rate between service providers. This information is useful to both landline and wireless service providers in determining who is gaining and who is losing subscribers in a particular market. The Local Number Portability database DIPs are so fast and inexpensive that it is feasible to perform the DIPs for all telephone numbers and all MDNs in a market. Accordingly, errors will be eliminated because the entire population of the market can be sampled.

Since all MDNs in a market can be quickly and inexpensively tested using the Local Number Portability database, a subscriber churn history statistic can be calculated. Specifically, by testing the MDNs over a period of time, the number of times a particular MDN has been ported over the period of time can be tracked. This information can be very useful to service providers as it shows which subscribers are more likely to stay with a service provider, and which are more likely to change service providers. Of course, a subscriber which changes wireless service providers every month is less attractive to a service provider than a subscriber which has not switched service providers for two years. Similarly, all telephone numbers for a market, whether wireless or landline, can be tested in a like manner.

Similarly, this data can be used to identify the percentage of customers that switch from pre-paid to post-paid but maintain their previous number. In one embodiment, this determination is made by comparing the pre-paid and post-paid classifications for test numbers between the current reporting period and the prior reporting period.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for determining at least one market statistic for one or more wireless communications service provider comprising:
testing a plurality of telephone numbers that are assigned by wireless service providers to their customer base to obtain at least one response;
interpreting the response to determine whether the assigned numbers are assigned to a pre-paid customer or to a post-paid subscriber; and
generating market statistics based on the at least one response.

2. The method of claim 1, wherein the testing comprises sending a message to a database associated with at least one of the plurality of telephone numbers and wherein the determination of whether a number is assigned and whether assigned numbers are pre-paid or post-paid employs the response to said message.

3. The method of claim 2, wherein the database is a wireless service provider home location registry.

4. The method of claim 3, wherein the message is sent over the SS7 network to query the home location registry.

5. The method of claim 2, wherein the message is sent to a local number portability database.

6. The method of claim 1, wherein the interpretation of the response employs ISDN call set-up signaling.

7. The method of claim 6, wherein the pre-paid/post-paid determination is made using information contained in a Call Progress Indicator message.

8. The method of claim 1, wherein the pre-paid/post-paid determination is determined as a static attribute of line number ranges allocated to wireless service providers.

9. The method of claim 1, wherein the pre-paid/post-paid determination is determined using information from a wireless service provider's billing system.

10. The method of claim 9, further comprising accessing a network to obtain information from the billing system.

11. The method of claim 10, wherein the billing system information is made accessible by the wireless service provider.

12. The method of claim 1, wherein the determination of whether a number is assigned or whether assigned numbers are pre-paid or post-paid is made through manual means.

13. The method of claim 1, wherein the market statistics include at least one of market share, gross adds, subscriber churn, pre-paid vs post-paid market share and number transitions to or from pre-paid and post-paid status.

14. The method of claim 13 comprising calculating the number of existing customers that have changed from pre-paid to post-paid or from post-paid to pre-paid over a specified period.

15. The method of claim 13 comprising determining the total number of subscribers for a given provider and either or both of the total number of pre-paid and post-paid subscribers for that provider.

16. The method of claim 1 wherein the interpretation of the response employs an automated SS7 signal interpretation algorithm.

17. A method for determining market statistics delineating the percentage of pre-paid customers compared to post-paid subscribers for one or more wireless communications service providers comprising determining whether a number is assigned to a carrier, accessing a billing system of said carrier and extracting call data records relating to at least one number.

18. A system adapted to determine whether a telephone number associated with a wireless communication device is assigned to a pre-paid customer or to a post-paid subscriber, the system comprising a data collection component comprising a SS7 test device adapted to coordinate testing of a sample of numbers, which test device interfaces to a SS7 network, a central server, at least one data collection node adapted to control the test device coordinating the testing of a sample of numbers, the at least one node connected via a network connection to the central server, the central server adapted to use publicly available data about wireless service provider line number range assignments to generate, maintain, and store carrier-market samples, and at least one reporting mechanism.

19. The invention according to claim 18 wherein there is one-to-one correspondence between plural data collection nodes and test equipment.

20. The invention according to claim 18 wherein a single node controls multiple test devices.

21. The invention according to claim 18 wherein the central server is adapted to schedule and load-balance the execution of carrier-market sample tests across plural data collection nodes.

22. The invention according to claim 18 wherein the central server is adapted to store test results for a period necessary to generate a report.

23. The invention according to claim 18 wherein the central server serves as a test controller and data storage warehouse.

24. The invention according to claim 18 wherein the at least one reporting mechanism comprises an Online Analytical Processing (OLAP) mechanism.

25. The invention according to claim 18 wherein the test device is connected via a direct A link connection to a Signal Transfer Point (STP).

26. The invention according to claim 18 wherein the test device is connected via a monitoring link to an existing A link.
